(19) United States
(12) Patent Application Publication
(10) Pub. No.: US 2015/0185950 A1
(43) Pub. Date: Jul. 2, 2015

(54) CONTROL DEVICE, CONTROL METHOD, AND PROGRAM

(71) Applicant: Sony Corporation, Tokyo (JP)

(72) Inventors: Takuo Watanabe, Tokyo (JP); Ikuo Yamano, Tokyo (JP); Shinpei Kameoka, Tokyo (JP)

(21) Appl. No.: 14/573,403

(22) Filed: Dec. 17, 2014

(30) Foreign Application Priority Data
Dec. 27, 2013 (JP) 2013-272938

(51) Int. Cl. G06F 3/041; H04N 5/44; G06F 3/046; G06F 3/0481

(52) U.S. Cl. CPC G06F 3/0416; G06F 3/04812; H04N 5/4403; G06F 3/046; H04N 2005/4412; H04N 2005/443; H04N 2005/4444; G06F 2203/04101; G06F 2203/04808

(57) ABSTRACT

A control device includes an area change unit that changes an assignment area which is a part of a touch detection area where a touch of a user is detected and is an area to which a predetermined function is assigned depending on a start position of a touch of the user or a position obtainment period during which a touch position of the user is obtained.

### CROSS REFERENCE TO RELATED APPLICATIONS

This application claims the benefit of Japanese Priority Patent Application JP 2013-272938 filed Dec. 27, 2013, the entire contents of which are incorporated herein by reference.

### BACKGROUND

The present technology relates to a control device, a control method, and a program, and particularly to a control device, a control method, and a program that can, for example, improve operability of a touchpad, a touch panel, or the like.

Regarding a remote controller that remotely controls, for example, a television receiver (TV), a technology is proposed in which a user can easily recognize functions assigned to each button of the remote controller (for example, Japanese Unexamined Patent Application Publication No. 2003-223265).

### SUMMARY

Incidentally, the user may erroneously operate a device (hereinafter, also referred to as a touch device) like a remote controller with a touchpad and a terminal with a touch panel that includes a touch sensor such as a touchpad or a touch panel which detects a touch (operation) of the user. Thus, processes may be performed against the intention of the user.

Accordingly, operability of the touch device may not be favorable from the standpoint of the user.

It is desirable that the operability be able to be improved.

According to an embodiment of the present technology, there are provided a control device and a program. The control device includes an area change unit that changes an assignment area which is a part of a touch detection area where a touch of a user is detected and is an area to which a predetermined function is assigned depending on a start position of a touch of the user or a position obtainment period during which a touch position of the user is obtained. The program causes a computer to function as the control device.

According to another embodiment of the present technology, there is provided a control method including changing an assignment area that is a part of a touch detection area where a touch of a user is detected and is an area to which a predetermined function is assigned depending on a start position of a touch of the user or a position obtainment period during which a touch position of the user is obtained.

In the control device, the control method, and the program, the assignment area that is the part of the touch detection area where the touch of the user is detected and is the area to which the predetermined function is assigned is changed depending on the start position of the touch of the user or the position obtainment period during which the touch position of the user is obtained.

The control device may be an independent device or may be an internal block that constitutes one device.

The program may be provided by being transferred via a transfer medium or being recorded in a recording medium.

According to the present technology, operability can be improved.

The effect described here is not necessarily limited and may be any effect described in the present disclosure.

### BRIEF DESCRIPTION OF THE DRAWINGS

FIG. 1 is a perspective view illustrating a configuration example of an embodiment of a TV system to which the present technology is applied;

FIG. 2 is a perspective view illustrating a configuration example of the exterior of a remote controller;

FIG. 3 is a plan view illustrating a configuration example of an operation panel of the remote controller;

FIG. 4 is a block diagram illustrating an electrical configuration example of the remote controller and a TV;

FIG. 5 is a plan view illustrating a schematic configuration example of a touchpad;

FIGS. 6A and 6B are diagrams illustrating an example of an erroneous operation of a user;

FIGS. 7A and 7B are diagrams illustrating an example of changing a swipe area depending on the start position of a touch;

FIG. 8 is a diagram illustrating a first restoration method that restores a changed swipe area to a default swipe area;

FIG. 9 is a diagram illustrating a second restoration method that restores the changed swipe area to the default swipe area;

FIG. 10 is a flow chart illustrating an example of a process of changing the swipe area depending on the start position of a touch;

FIGS. 11A and 11B are diagrams illustrating an example of changing the swipe area depending on a position obtainment period;

FIG. 12 is a flow chart illustrating an example of a process of changing the swipe area depending on the position obtainment period;

FIGS. 13A and 13B are diagrams illustrating prediction of the start position of a touch based on the velocity of movement of a swipe operation;

FIG. 14 is a diagram illustrating a specific example of a prediction method that predicts the start position of a touch on the basis of the velocity of movement of a swipe operation;

FIG. 15 is a diagram illustrating an example of a temporal change in a detected position that is detected as a touch position;

FIG. 16 is a plan view illustrating a schematic configuration example of the touchpad;

FIGS. 17A and 17B are plan views illustrating a configuration example of a part of the operation panel of the remote controller;

FIG. 18 is a plan view illustrating a configuration example of an embodiment of a terminal to which the present technology is applied; and

FIG. 19 is a block diagram illustrating a configuration example of an embodiment of a computer to which the present technology is applied.

### DETAILED DESCRIPTION OF EMBODIMENTS

An Embodiment of a TV System to which the Present Technology is Applied

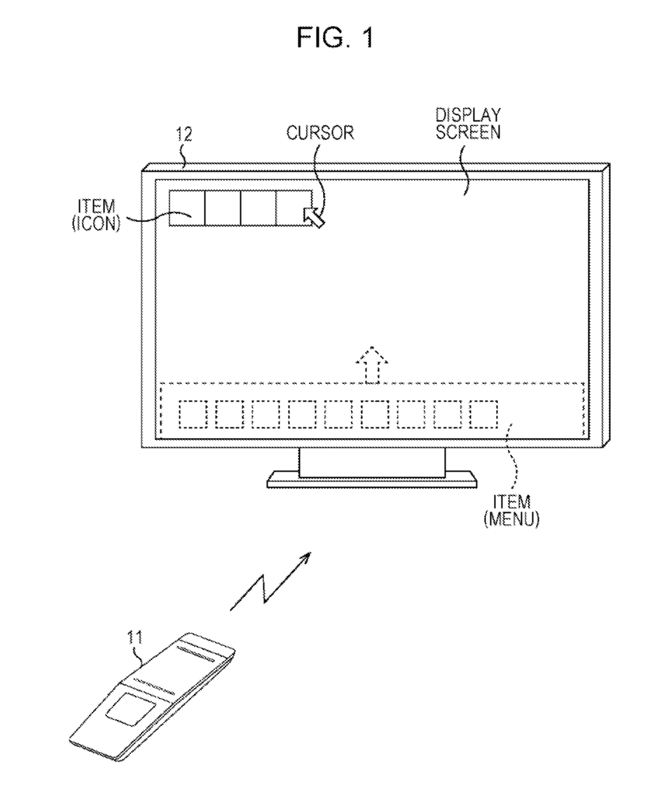

FIG. 1 is a perspective view illustrating a configuration example of an embodiment of a TV system to which the present technology is applied.

The TV system includes a remote controller 11 and a TV 12 in FIG. 1.

The remote controller 11 is operated by a user and transmits an operation signal that corresponds to an operation of the user.

Transmitting the operation signal by the remote controller 11 may be performed through any method between wired communication and wireless communication.

In a case of transmitting the operation signal by the remote controller 11 through wireless communication, for example, infrared communication, wireless local area network (LAN), Bluetooth (registered trademark), or any other communication methods can be adopted as the wireless communication.

The TV 12 receives contents of a television broadcast, contents that are reproduced in external devices, contents that are transmitted via networks such as the Internet, and the like, displays images of the contents on a display screen, and outputs audio.

Besides, the TV 12, for example, starts a browser and displays a web page (images thereof) of the Internet on the display screen.

In addition, the TV 12 displays a cursor on the display screen when necessary. Furthermore, the TV 12 displays an item that can be selected or operated by the cursor as a graphical user interface (GUI) on the display screen when necessary.

For example, a menu for guiding an operation, a function, and the like, an icon as a symbol of contents are exemplified as the item displayed in the TV 12.

In addition, an item that is momentarily switched between being displayed and being not displayed at a predetermined position on the display screen as illustrated by a solid rectangle in FIG. 1, an item that appears when a slide is performed from an end portion (a lower portion in FIG. 1) of the display screen in a direction as illustrated by an dotted arrow and disappears when a slide is performed in a direction to the end portion, and the like are exemplified as the item displayed in the TV 12.

In the present embodiment, displays that change the luminance, the color, the shape (including the size), and the like of an item so that the user can recognize that the item is focused are included in the cursor besides images that are explicitly displayed as the cursor such as an arrow, a rectangle (the frame thereof), and the like.

The TV 12 receives the operation signal transmitted from the remote controller 11 and performs various processes in response to the operation signal.

That is, the TV 12, for example, changes a channel for selecting a station that is selected and volume in response to the operation signal from the remote controller 11.

In addition, the TV 12, for example, performs processes such as moving the cursor, switching between displaying an item or not displaying an item, reproducing contents, and a process assigned to an item in response to the operation signal of the remote controller 11.

Configuration Example of the Exterior of the Remote Controller 11

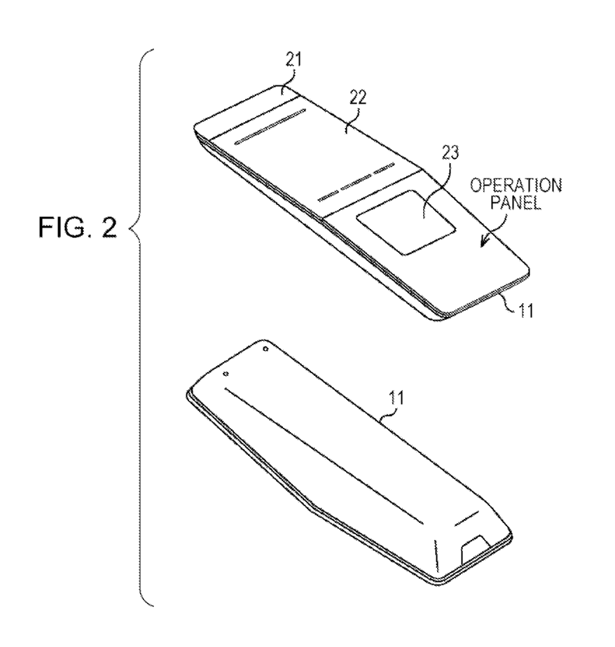

FIG. 2 is a perspective view illustrating a configuration example of the exterior of the remote controller 11 in FIG. 1.

The remote controller 11 is shaped like a rectangular parallelepiped and a substantially flat plate.

A hard key unit 21, a touchpad 22, and a hard key unit 23 that are operated by the user are disposed on one surface of the flat plate as the remote controller 11.

The hard key unit 21 is disposed in the upper portion of the remote controller 11.

The touchpad 22 is disposed down the hard key unit 21 in the form of being adjacent to the hard key unit 21.

The hard key unit 23 is disposed at a position slightly away from the touchpad 22 down the touchpad 22.

The surface of the remote controller 11 where the hard key unit 21, the touchpad 22, and the hard key unit 23 that are operated by the user are disposed is hereinafter referred to as an operation panel.

Each of the state of the remote controller 11 where the operation panel faces upward and the state of the remote controller 11 where the operation panel faces downward is illustrated in FIG. 2.

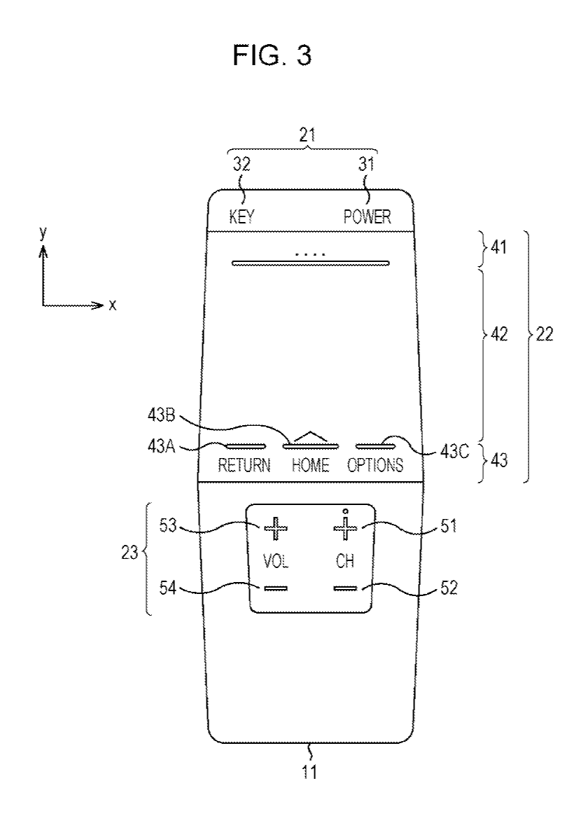

FIG. 3 is a plan view illustrating a configuration example of the operation panel of the remote controller 11.

Hard keys 31 and 32 are disposed in the hard key unit 21.

The hard key 31 is a power key. The power of the TV 12 is ON or OFF when the hard key 31 is operated (pushed).

The hard key 32 is a special key. The TV 12 performs a predetermined process assigned to the hard key 32 when the hard key 32 is operated (pushed).

The touchpad 22 is operated when moving the cursor displayed in the TV 12 or in other various cases.

In FIG. 3, the touchpad 22 is shaped like a substantial trapezoid and is sectioned into an area 41 on the upper base side (upper portion) of the trapezoid, an area 43 on the lower base side (lower portion), and an area 42 in the center portion interposed between the areas 41 and 43.

The TV 12, for example, changes the channel for selecting a station in a way that the channel number increases to be greater than the current channel number when the area 41 is operated by a swipe from the right to the left in the horizontal direction (x direction). Here, a swipe operation means an operation of moving the position of a touch while a finger or the like is being touched on the touchpad 22.

The TV 12, for example, changes the channel for selecting a station in a way that the channel number decreases to be smaller than the current channel number when the area 41 is operated by a swipe from the left to the right.

The touchpad 22 can be pushed to be operated. The TV 12, for example, displays the remote controller (the image thereof) for controlling the TV 12 on the display screen when the area 41 is pushed to be operated (when a push operation is performed on the touchpad 22 while the area 41 is being touched).

The area 42 is swiped to be operated when moving the cursor displayed in the TV 12 and the like. That is, the cursor displayed in the TV 12, for example, moves in response to a swipe operation in the area 42 when the area 42 is swiped to be operated.

In addition, the TV 12, for example, performs the same process as that in a case where a so-called decision key is operated when the area 42 is pushed to be operated.

Furthermore, the TV 12, for example, performs the same process as that in a case where a so-called cursor key is operated when the area 42 is flicked to be operated. Here, a flick operation means an operation of moving a finger like sweeping away while the finger or the like is being touched on the touchpad 22.

Three keys (buttons) 43A, 43B, and 43C are disposed in the area 43 in the horizontal direction.

The TV 12, for example, performs the same process (process of returning to the previous state) as that in a case where a so-called return key is operated when the key 43A is pushed to be operated.

The TV 12, for example, performs the same process (process of displaying a home screen) as that in a case where a so-called home key is operated when the key 43B is pushed to be operated. The TV 12, for example, displays a broadcast selection screen for selecting a broadcast on the display screen when a part of the key 43B is swiped to be operated in the vertically upward direction (y direction).

The TV 12, for example, performs the same process (for example, a process of displaying an option menu) as that in a case where a so-called option key is operated when the key 43C is pushed to be operated.

Hard keys 51, 52, 53, and 54 are disposed in the hard key unit 23.

The hard key 51, for example, is operated (pushed) when incrementing the channel for selecting a station in the TV 12. The hard key 52, for example, is operated (pushed) when decrementing the channel for selecting a station in the TV 12.

The hard key 53, for example, is operated (pushed) when increasing volume in the TV 12. The hard key 54, for example, is operated (pushed) when decreasing volume in the TV 12.

### Electrical Configuration Example of the Remote Controller 11 and the TV 12

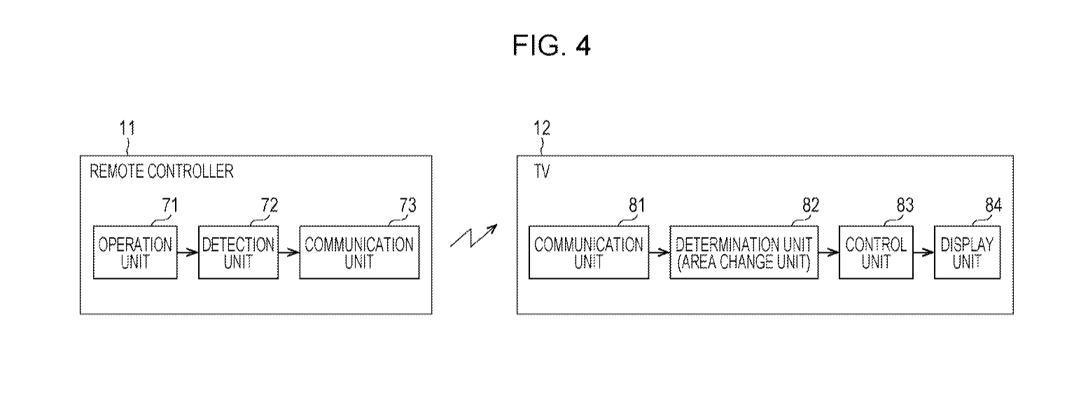

FIG. 4 is a block diagram illustrating an electrical configuration example of the remote controller 11 and the TV 12 in FIG. 1.

The remote controller 11 includes an operation unit 71, a detection unit 72, and a communication unit 73.

The operation unit 71 corresponds to the hard key unit 21, the touchpad 22, and the hard key unit 23 (FIG. 3) and is operated by the user.

The detection unit 72 detects the operation of the operation unit 71 by the user and supplies the operation signal corresponding to the operation to the communication unit 73.

The communication unit 73 wirelessly transmits the operation from the detection unit 72.

The TV 12 includes a communication unit 81, a determination unit 82, a control unit 83, and a display unit 84.

The communication unit 81 receives the operation signal transmitted from the remote controller 11 (the communication unit 73 thereof) and supplies the operation signal to the determination unit 82.

Based on the operation signal from the communication unit 81, the determination unit 82 determines the operation of the remote controller 11 by the user by detecting the position where the touchpad 22 is touched (touch position), an area of the touchpad 22 within which the touch position is positioned, or whether the touchpad 22 or the like is pushed.

Furthermore, based on the determination result of the operation of the remote controller 11, the determination unit 82 supplies (outputs) a command as instruction information that instructs the control unit 83 to move the cursor, to confirm selecting an item focused by the cursor, or to display the item to the control unit 83.

The control unit 83 controls the entire TV 12 according to the command or the like from the determination unit 82.

That is, the control unit 83, for example, controls the channel, volume, and the like according to the command from the determination unit 82.

In addition, the control unit 83, for example, controls the display of the cursor and items in the display unit 84 according to the command from the determination unit 82.

The display unit 84, for example, is configured of a liquid crystal display (LCD), an organic electroluminescence (EL) display, or the like and displays images of contents, items, and the cursor as a focus according to the control and the like of the control unit 83.

Assignment of Different Functions by Sectioning a Touch Detection Area into Multiple Assignment Areas

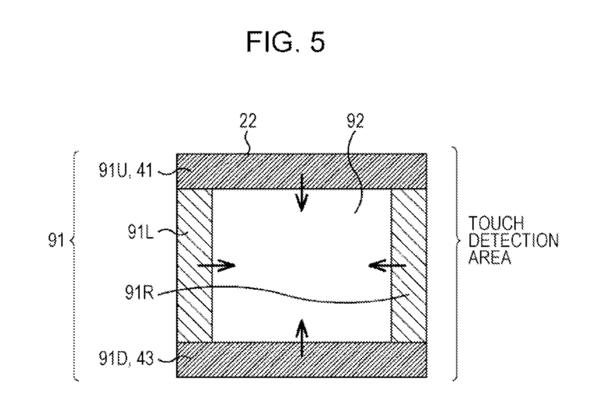

FIG. 5 is a plan view illustrating a schematic configuration example of the touchpad 22.

Here, an area (surface) where a touch of the user is detected is referred to as a touch detection area in the touchpad 22.

Directional functions of the TV 12 such as a function of selecting a channel (transmitting a channel), a “return” function of returning a web page displayed on the browser to a previous web page, and a “proceeding” function of proceeding to a next web page are desirably performed with an up-and-down or left-to-right operation as a trigger in view of providing intuitive operability to the user.

However, assigning other functions performed with a swipe operation as a trigger to the touch detection area is difficult when, for example, a cursor moving function of moving the cursor in response to a swipe operation is assigned to the entire touch detection area.

There, sectioning the touch detection area into multiple assignment areas that are multiple areas where different functions are assigned and assigning different functions to each assignment area allow the different functions to be performed with a swipe operation in each assignment area as a trigger.

In FIG. 5, the touch detection area is sectioned into an assignment area 91U that is a part of an area near the upper boundary, an assignment area 91D that is a part of an area near the lower boundary, an assignment area 91L that is a part of an area near the left boundary, an assignment area 91R that is a part of an area near the right boundary, and an assignment area 92 that is an area that remains at the center.

For example, functions other than directional functions are assigned to the assignment areas 91U, 91D, 91L, and 91R with an inward swipe operation from the boundary of the touch detection area as a trigger as illustrated by arrows. The cursor moving function of moving the cursor in response to a swipe operation of the user is assigned to the assignment area 92.

According to the above assignment of functions to the touch detection area, moving the cursor can coincide with performing other predetermined functions. That is, any of moving the cursor and performing other predetermined functions can be performed by a swipe operation.

The assignment areas 91U, 91D, 91L, and 91R are also collectively referred to as an assignment area 91 hereinafter.

In addition, for example, assigning predetermined functions performed with a swipe operation as a trigger to the assignment area 91 is also referred to as assigning predetermined functions to a swipe operation in the assignment area 91.

Furthermore, the assignment area 91 is also referred to as a swipe area 91, and the assignment area 92 is also referred to as a cursor area 92 hereinafter.

Besides functions performed with a swipe operation as a trigger, functions performed with operations other than a swipe operation as a trigger can also be assigned to the swipe area 91 and the cursor area 92.

For example, a function of displaying a broadcast selection screen can be assigned to an upward swipe operation (inward from the boundary of the touch detection area), and functions such as a return key function, a home key function, an option key function, and the like can be assigned to a push operation in the swipe area 91D.

In FIG. 5, the swipe area 91U on the upper side, for example, corresponds to the area 41 in FIG. 3, and the swipe area 91D on the lower side, for example, corresponds to the area 43 in FIG. 3.

The user is highly likely to operate the touchpad 22 erroneously when the touch detection area of the touchpad 22 is sectioned into the swipe area 91 and the cursor area 92, and different functions are assigned thereto as described above.

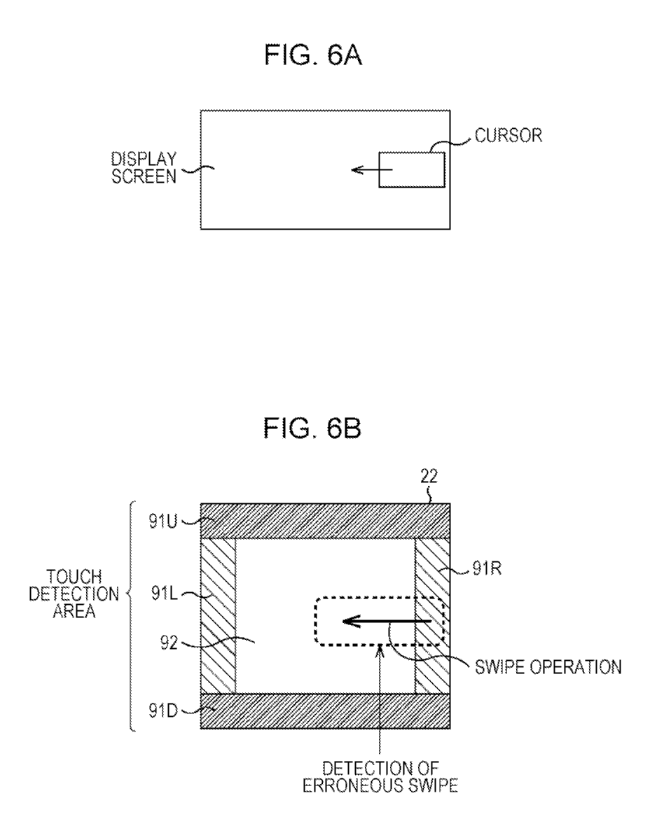

FIGS. 6A and 6B are diagrams illustrating an example of an erroneous operation of the user.

FIG. 6A illustrates an example of displaying the display screen of the display unit 84.

In FIG. 6A, a rectangular cursor is displayed at the right end of the display screen, and now the cursor moves toward the center from the right end of the display screen.

FIG. 6B illustrates an example of a swipe operation of the user on the touchpad 22 when moving the cursor in FIG. 6A.

Here, an absolute position on the touch detection area (the swipe area 91 and the cursor area 92) of the touchpad 22 and an absolute position on the display screen are not particularly related to each other.

However, the user, for example, tends to start touching unconsciously from a position corresponding to the position of the cursor on the touch detection area, that is, a position in the swipe area 91R arranged at the right end of the touch detection area and swipe toward the center when the cursor is displayed at the right end of the display screen as illustrated in FIG. 6A.

In the TV 12, the cursor is moved by a swipe operation started from the cursor area 92. However, when the swipe operation is started from the swipe area 91R as described above (when the user starts touching from the swipe area 91R and swipes), a function assigned to a swipe operation in the swipe area 91R is performed in the TV 12.

As described above, the user may start swiping unconsciously and erroneously from the swipe area 91R, not swiping from the cursor area 92 when moving the cursor.

Then, the function assigned to a swipe operation in the swipe area 91R is performed in the TV 12 against the intention of the user, and the cursor does not move against the intention of the user when such an erroneous operation is performed.

There, changing the swipe area 91 depending on the start position of a touch of the user reduces a likelihood of the erroneous operation of the user and improves operability of the touchpad 22 (further, the remote controller 11) in the TV 12.

### Changing the Swipe Area

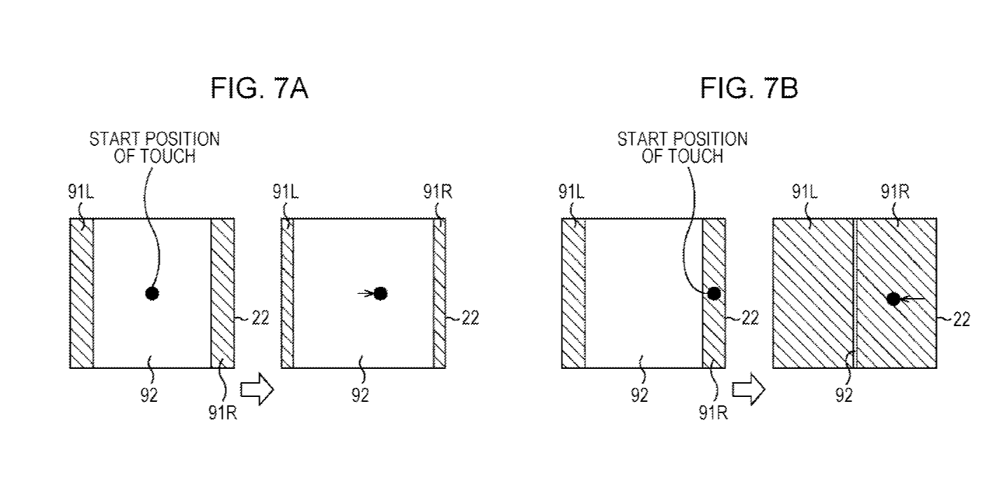

FIGS. 7A and 7B are diagrams illustrating an example of changing the swipe area 91 depending on the start position of a touch.

In the TV 12, the determination unit 82, for example, sections the touch detection area of the touchpad 22 into multiple assignment areas such as the swipe area 91 and the cursor area 92 depending on applications that the TV 12 executes.

In FIGS. 7A and 7B, the touch detection area of the touchpad 22 is sectioned into three assignment areas of the swipe areas 91L and 91R and the cursor area 92.

The determination unit 82 can function as an area change unit that changes the swipe areas 91L and 91R by enlarging or shrinking depending on the start position of a touch of the user on the touch detection area of the touchpad 22 when the touch detection area is sectioned into the multiple assignment areas as described above.

FIG. 7A is a diagram illustrating shrinkage of the swipe areas 91L and 91R.

When the start position of a touch in a swipe operation is positioned outside the swipe areas 91L and 91R, that is, positioned inside the cursor area 92, the determination unit 82 shrinks the swipe areas 91L and 91R (enlarges the cursor area 92) as illustrated in FIG. 7A.

In FIG. 7A, the horizontal width of the swipe areas 91L and 91R is decreased, and the horizontal width of the cursor area 92 is increased by the amount of the decrease.

FIG. 7B is a diagram illustrating enlargement of the swipe areas 91L and 91R.

When the start position of a touch in a swipe operation is positioned inside the swipe areas 91L and 91R, the determination unit 82 enlarges the swipe areas 91L and 91R (shrinks the cursor area 92) as illustrated in FIG. 7B.

In FIG. 7B, the horizontal width of the swipe areas 91L and 91R is increased, and as a consequence, the horizontal width of the cursor area 92 is decreased.

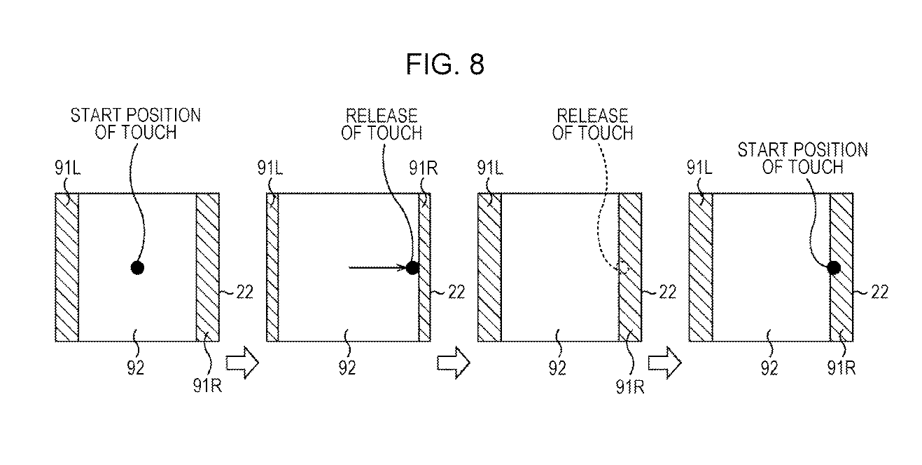

FIG. 8 is a diagram illustrating a first restoration method that restores the swipe areas 91L and 91R which are changed as illustrated in FIGS. 7A and 7B to the original swipe areas 91L and 91R (hereinafter, also referred to as the default swipe areas 91L and 91R).

In FIG. 8, the start position of a touch in a swipe operation is positioned inside the cursor area 92 outside the swipe areas 91L and 91R. Thus, the swipe areas 91L and 91R are shrunk (the cursor area 92 is enlarged).

In addition, in FIG. 8, the user swipes to move the touch position to the right as illustrated by an arrow and releases the touch at a position inside the cursor area 92 close to the swipe area 91R after being shrunk.

In this case, the start position of the touch is positioned inside the cursor area 92. Thus, for example, the cursor is moved in response to the swipe operation as a function assigned to the cursor area 92 (a swipe operation therein) in the TV 12.

In the first restoration method, the determination unit 82 restores the changed swipe areas (the swipe areas after being shrunk) 91L and 91R to the default swipe areas 91L and 91R immediately when the user releases the touch.

Now the user intends to resume moving the cursor and touches the position (the vicinity thereof) where the touch is released to start swiping immediately after the touch is released at the position close to the swipe area 91R after being shrunk as described above.

As described above, the swipe areas 91L and 91R after being shrunk are restored to the default swipe areas 91L and 91R immediately when the user releases the touch in the first restoration method. Thus, when the user intends to resume moving the cursor and touches the position (the vicinity thereof) where the touch is released to start swiping, the start position of the touch during the swipe operation may be positioned inside the swipe area 91R that is restored to the default state.

In this case, not the function of moving the cursor assigned to the cursor area 92 but the function assigned to the swipe area 91R is performed in the TV 12. That is, the cursor is not moved against the intention of the user.

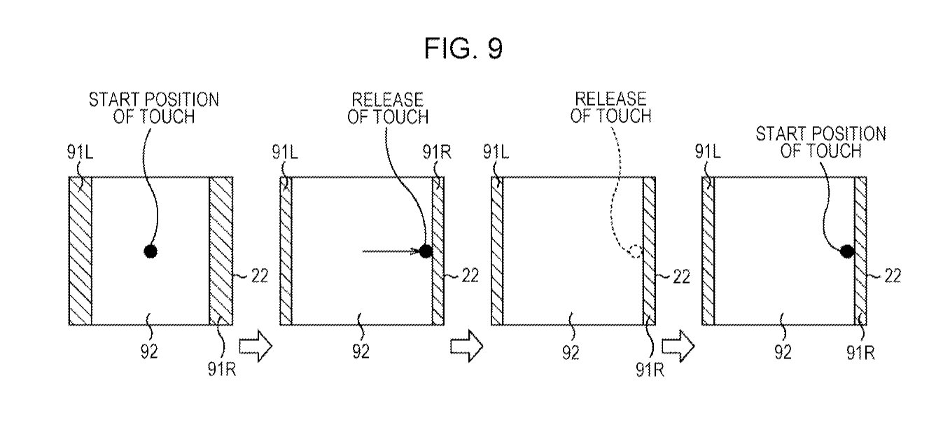

FIG. 9 is a diagram illustrating a second restoration method that restores the changed swipe areas 91L and 91R to the default swipe areas 91L and 91R.

In FIG. 9, a swipe operation to the right is performed with a position inside the cursor area 92 as the start position of a touch, and the touch is released at a position inside the cursor area 92 close to the swipe area 91R after being shrunk like in the case in FIG. 8.

In the second restoration method, the determination unit 82 maintains the changed swipe areas (the swipe areas after being shrunk) 91L and 91R even after the user releases the touch and restores the changed swipe areas 91L and 91R to the default swipe areas 91L and 91R after a predetermined period elapses.

Like in the case in FIG. 8, now the user intends to resume moving the cursor and touches the position (the vicinity thereof) where the touch is released to start swiping immediately after the touch is released at the position close to the swipe area 91R after being shrunk as described above.

In the second restoration method, the swipe areas 91L and 91R after being shrunk are maintained until a predetermined period elapses even though the user releases the touch as illustrated in FIG. 9.

Accordingly, even if the user intends to resume moving the cursor and immediately touches the position where the touch is released to start swiping, the start position of the touch in the swipe operation is positioned inside the cursor area 92 close to the swipe area 91R after being shrunk like when the touch is released.

As a consequence, the function of moving the cursor assigned to the cursor area 92 is performed, and the function assigned to the swipe area 91R is not performed in the TV 12 like in the case in FIG. 8.

As described above, the swipe areas 91L and 91R are shrunk (the cursor area 92 is enlarged) when the start position of the touch is positioned outside the swipe areas 91L and 91R (when positioned inside the cursor area 92). The swipe areas 91L and 91R are enlarged (the cursor area 92 is shrunk) when the start position of the touch is positioned inside the swipe areas 91L and 91R (when positioned outside the cursor area 92). The swipe areas 91L and 91R (the cursor 92) are maintained to be shrunk or enlarged from when the touch is released and are restored to the default swipe areas 91L and 91R (the cursor area 92) after a predetermined period elapses. Thus, operability of the touchpad 22 can be improved.

That is, unintended performance of the function assigned to the swipe areas 91L and 91R can be suppressed even when the user, for example, momentarily releases the touch at a position close to the swipe areas 91L and 91R and starts touching the position again in the middle of swiping the cursor area 92 to move the cursor.

In addition, the channel can be easily changed in a direction of increasing or decreasing the channel number by repeating a swipe operation in the horizontal direction in the area 41 that is the swipe area 91U when a function of changing the channel is assigned to a swipe operation in the horizontal direction in the area 41 that is the swipe area 91U as illustrated in FIG. 3.

A function of displaying the menu that appears when a slide is performed from the end portion of the display screen as illustrated in FIG. 1 with a touch as a trigger can be assigned to the swipe area 91.

In this case, the cursor can be displayed on the menu, and the cursor can be moved on the menu in response to a swipe operation that moves a touch position while the touch in the swipe area 91 is maintained.

In addition, the menu can be moved like sliding to the end portion of the display screen to disappear in response to the release of the touch in the swipe area 91.

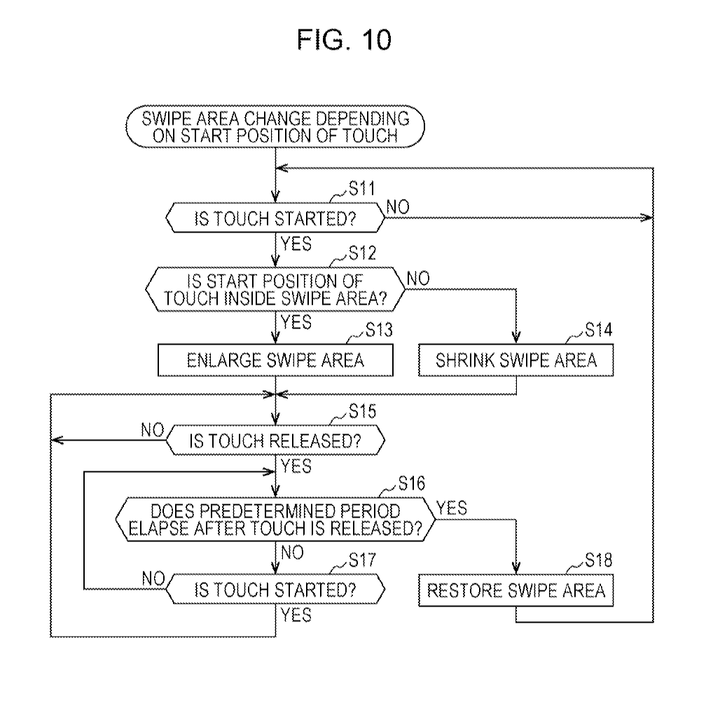

FIG. 10 is a flow chart illustrating an example of a process of changing the swipe area 91 depending on the start position of a touch.

The determination unit 82 determines whether a touch is started in the touch detection area of the touchpad 22 on the basis of the operation signal from the communication unit 81 in step S11. When determined that a touch is not started, the process returns to step S11.

Meanwhile, when determined that a touch is started in step S11, the process proceeds to step S12. The determination unit 82 determines whether the position where the touch is started on the touch detection area (the start position of the touch) is positioned inside the swipe area 91.

When determined that the start position of the touch is positioned inside the swipe area 91 in step S12, the process proceeds to step S13. The determination unit 82 enlarges the swipe area 91, and the process proceeds to step S15.

Meanwhile, when determined that the start position of the touch is not positioned inside the swipe area 91 in step S12, the process proceeds to step S14. The determination unit 82 shrinks the swipe area 91, and the process proceeds to step S15.

The determination unit 82 determines whether the touch in the touch detection area of the touchpad 22 is released on the basis of the operation signal from the communication unit 81 in step S15. When determined that the touch is not released, the process returns to step S15.

Meanwhile, when determined that the touch is released in step S15, the process proceeds to step S16. The determination unit 82 determines whether a predetermined period elapses after the touch (immediately before) is released.

When determined that a predetermined period does not elapse after the touch is released in step S16, the process proceeds to step S17. The determination unit 82 again determines whether a touch is started like in the case in step S11.

When determined that a touch is not started in step S17, the process returns to step S16. Thereafter, the same process is repeated.

Meanwhile, when determined that a touch is started in step S17, that is, when a touch is started again before a predetermined period elapses after the touch is released, the process returns to step S15. Thereafter, the same process is repeated.

Accordingly, in this case, the determination unit 82 does not restore the swipe area 91 enlarged in step S13 or the swipe area 91 shrunk in step S14 and continues to maintain the swipe area 91 as it is.

Meanwhile, when determined that a predetermined period elapses after the touch is released in step S16, that is, when a predetermined period elapses after the touch is released and is not started again, the process proceeds to step S18. The determination unit 82 restores the swipe area 91 enlarged in step S13 or the swipe area 91 shrunk in step S14 to the default swipe area 91.

Then, the process returns to step S11 from step S18. Thereafter, the same process is repeated.

In the present embodiment, the swipe area 91 after being changed (enlarged or shrunk) is not restored and is maintained as it is when a touch is started again before a predetermined period elapses after the touch is released. Restoration of the swipe area 91 that restores the swipe area 91 to the default swipe area 91 is performed when a predetermined period elapses after the touch is released. However, the restoration of the swipe area 91 can be exceptionally performed even before a predetermined period elapses after the touch is released when, for example, the function assigned to the swipe area 91 is changed by a change or the like of applications executed in the TV 12.

As described above, the restoration of the swipe area 91 is performed even before a predetermined period elapses after the touch is released when the function assigned to the swipe area 91 is changed. This can suppress an operation of the user on the touchpad 22 after the function assigned to the swipe area 91 is changed being erroneous.

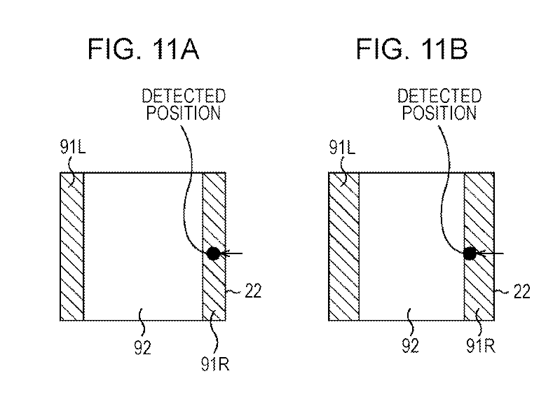

FIGS. 11A and 11B are diagrams illustrating an example of changing the swipe area 91 depending on a position obtainment period.

In the remote controller 11 or the TV 12, a position obtainment period that is a period of obtaining a touch position on the touchpad 22 (for example, a period in which a touch position on the touchpad 22 is detected by the detection unit 72 of the remote controller 11, a period in which a touch position is transmitted from the remote controller 11 to the TV 12, a period in which the determination unit 82 of the TV 12 receives the operation signal representing a touch position or the like from the communication unit 81, a period in which the determination unit 82 detects a touch position on the basis of the operation signal from the communication unit 81, and the like) may be delayed from normal for a power saving.

A detected position detected as the start position of a touch in a swipe operation in a direction toward the center from the swipe area 91 on the boundary side of the touch detection area of the touchpad 22 may be further inside (center side) the touch detection area than the actual start position of the touch when the position obtainment period is delayed.

In this case, the actual start position of the touch is positioned inside the swipe area 91, but the determination unit 82 determines that the start position of the touch (the detected position detected thereas) is positioned outside the swipe area 91. As a consequence, the operation of the user may be erroneous.

There, in the TV 12, changing the swipe area 91 depending on the position obtainment period reduces a likelihood of the erroneous operation of the user and improves operability of the touchpad 22 (further, the remote controller 11).

FIGS. 11A and 11B are diagrams illustrating an example of changing the swipe area 91 depending on the position obtainment period.

In the TV 12, the determination unit 82, for example, sections the touch detection area of the touchpad 22 into multiple assignment areas such as the swipe area 91 and the cursor area 92 depending on applications that the TV 12 executes.

In FIGS. 11A and 11B, the touch detection area of the touchpad 22 is sectioned into three assignment areas of the swipe areas 91L and 91R and the cursor area 92 like in the case in FIGS. 7A and 7B.

The determination unit 82 can function as the area change unit that changes the swipe areas 91L and 91R by enlarging depending on the position obtainment period when the touch detection area is sectioned into the multiple assignment areas as described above.

FIG. 11A is a diagram illustrating an example of the detected position detected as the start position of a touch in a swipe operation in a direction from the swipe area 91R toward the center (inside) of the touch detection area of the touchpad 22 when the position obtainment period is normal.

In FIG. 11A, the user intends to perform the function assigned to the swipe area 91R and starts touching a position in the vicinity of the right boundary of the touch detection area where the swipe area 91R is arranged. Thereafter, the user moves the touch position toward the center of the touch detection area (hereinafter, also referred to as a leftward swipe operation).

The detected position detected as the start position of the touch in the leftward swipe operation is positioned inside the default swipe area 91R, not dislocated so far from the actual start position of the touch when the position obtainment period is normal.

In this case, the function assigned to the swipe area 91R is performed in accordance with the intention of the user in the TV 12.

For this reason, the determination unit 82 does not change the swipe areas 91L and 91R and maintains the default state thereof when the position obtainment period is normal.

FIG. 11B is a diagram illustrating an example of the detected position detected as the start position of a touch in a leftward swipe operation when the position obtainment period is delayed from normal for a power saving or the like.

In FIG. 11B, the user intends to perform the function assigned to the swipe area 91R and performs a leftward swipe operation like in the case in FIG. 11A.

When the position obtainment period is delayed from normal, a timing of detecting a touch position (the start position of a touch) from the start of the touch in the touch detection area of the touchpad 22 may be delayed from that in the case where the position obtainment period is normal.

For this reason, the detected position detected as the start position of the touch in the leftward swipe operation may be positioned inside (center side) the touch detection area, further dislocated in the direction of the leftward swipe operation than that in the case where the position obtainment period is normal.

In this case, the detected position detected as the start position of the touch in the leftward swipe operation is positioned outside the default swipe area 91R. As a consequence, the function assigned to the swipe area 91R is not performed, and the function of moving the cursor assigned to the cursor area 92 is performed against the intention of the user in the TV 12.

For this reason, the determination unit 82 enlarges the swipe areas 91L and 91R as illustrated in FIG. 11B when the position obtainment period is delayed from normal.

In FIG. 11B, the horizontal width of the swipe areas 91L and 91R is increased greater than that in the case of the default swipe areas 91L and 91R like in the case in FIG. 7B.

As described above, enlarging the swipe areas 91L and 91R when the position obtainment period is delayed can suppress the detected position detected as the start position of the touch in the leftward swipe operation being positioned outside the default swipe area 91R, thus not performing the function assigned to the swipe area 91R against the intention of the user in the TV 12.

Accordingly, even when the position obtainment period is delayed, the user can perform a swipe operation with the same sense as that in the case where the position obtainment period is normal. Thus, operability of the touchpad 22 can be improved.

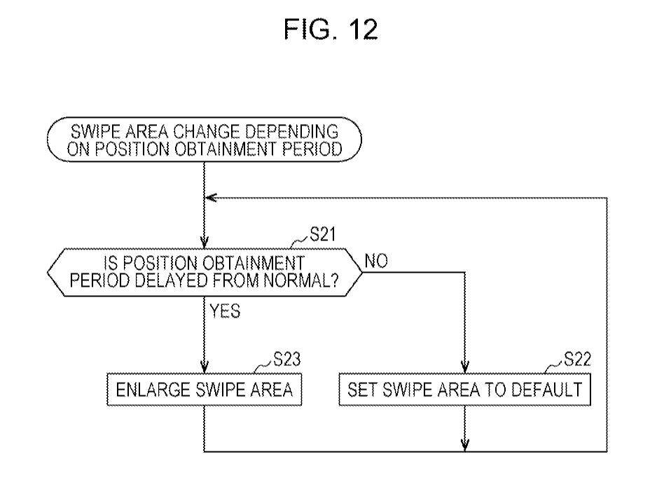

FIG. 12 is a flow chart illustrating an example of a process of changing the swipe area 91 depending on the position obtainment period.

The determination unit 82 determines whether the position obtainment period is delayed from normal for a power saving or the like in step S21.

When determined that the position obtainment period is not delayed from normal in step S21, that is, when the position obtainment period is normal, the process proceeds to step S22. The determination unit 82 restores the swipe area 91 to the default state if the swipe area 91 is enlarged.

Meanwhile, when determined that the position obtainment period is delayed from normal in step S21, the process proceeds to step S23. The determination unit 82 enlarges the swipe area 91.

After any of step S22 or step S23, the process returns to step S21. Thereafter, the same process is repeated.

Prediction of the Start Position of a Touch Based on the Velocity of Movement

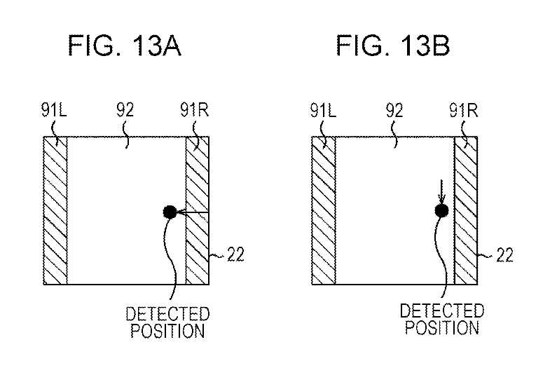

FIGS. 13A and 13B are diagrams illustrating prediction of the start position of a touch based on the velocity of movement of a swipe operation (touch).

In FIGS. 13A and 13B, the touch detection area of the touchpad 22 is sectioned into three assignment areas of the swipe areas 91L and 91R and the cursor area 92 like in the case in FIGS. 7A and 7B.

The detected position detected as the start position of a touch may not match the actual start position of a touch when the timing of the start of a touch and the timing of detecting a touch position (sampling a touch position) in accordance with the position obtainment period in the detection unit 72 (FIG. 4) are different from each other.

For this reason, even when, for example, the user intends to perform the function assigned to the swipe area 91R and starts touching from a position inside the swipe area 91R to perform a swipe operation, the detected position detected as the start position of the touch may be positioned outside the swipe area 91R, and the function assigned to the swipe area 91R may not be performed.

There, the determination unit 82 can predict the start position of the touch on the basis of the velocity of the movement of the swipe operation (touch) and treat the predicted position obtained from the prediction result as the start position of the touch.

As the predicted position obtained by predicting the start position of the touch, for example, a position returned from the detected position detected as the start position of the touch in a direction opposite to the direction of the swipe operation by a distance corresponding to the speed of the velocity of the movement of the swipe operation can be adopted.

FIG. 13A illustrates a first example of a swipe operation.

In FIG. 13A, the user, for example, intends to perform the function assigned to the swipe area 91R and starts touching from a position inside the swipe area 91R to perform a swipe operation to the left.

However, the detected position detected as the start position of the touch is dislocated from the actual start position of the touch (a position inside the swipe area 91R) to the left that is the direction of movement of the swipe operation and is positioned outside the swipe area 91R in FIG. 13A.

In this case, the determination unit 82 obtains a position returned from the detected position detected as the start position of the touch in the direction opposite to the direction of the swipe operation by a distance corresponding to the speed of the velocity of the movement of the swipe operation, that is, for example, the position of the start point of an arrow illustrated in FIG. 13A as the predicted position of the start position of the touch.

The position of the start point of the arrow illustrated in FIG. 13A is positioned inside the swipe area 91R. When the predicted position of the start position of the touch in the swipe operation is positioned inside the swipe area 91R, the function assigned to the swipe area 91R is performed in the TV 12.

FIG. 13B illustrates a second example of a swipe operation.

In FIG. 13B, the user, for example, intends to perform the function of moving the cursor assigned to the cursor area 92 and starts touching from a position inside the cursor area 92 close to the swipe area 91R to perform a swipe operation downward.

However, the detected position detected as the start position of the touch is dislocated from the actual start position of the touch (a position inside the cursor area 92) in a downward direction that is the direction of movement of the swipe operation and is positioned inside the cursor area 92 in FIG. 13B.

In this case, the determination unit 82 obtains a position returned from the detected position of the start position of the touch in the direction opposite to the direction of the swipe operation by a distance corresponding to the speed of the velocity of the movement of the swipe operation, that is, the position of the start point of an arrow illustrated in FIG. 13B as the predicted position of the start position of the touch.

The position of the start point of the arrow illustrated in FIG. 13B is positioned inside the cursor area 92. When the predicted position of the start position of the touch in the swipe operation is positioned inside the cursor area 92, the function of moving the cursor assigned to the cursor area 92 is performed in the TV 12.

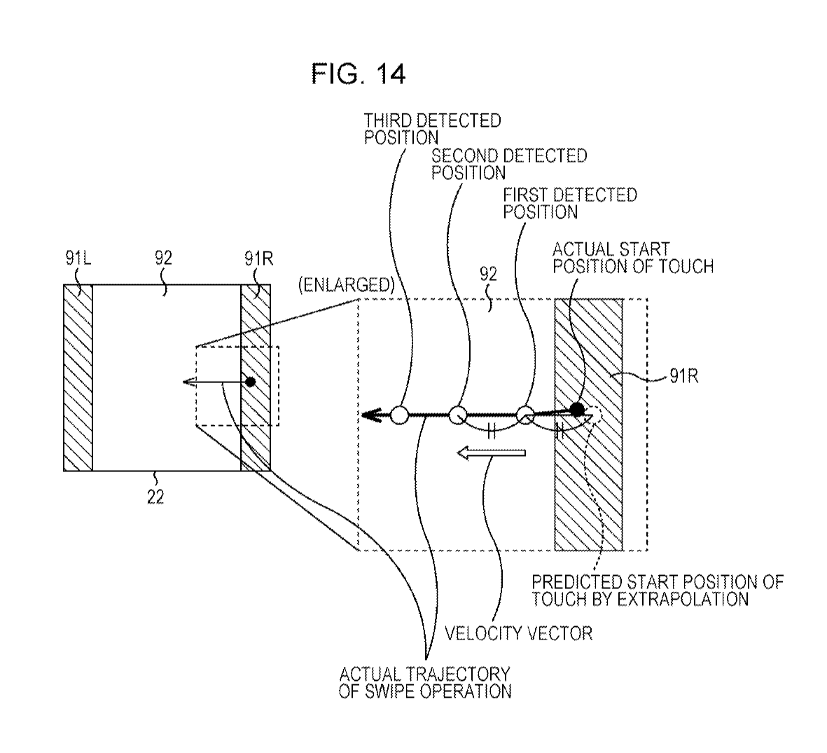

FIG. 14 is a diagram illustrating a specific example of a prediction method that predicts the start position of a touch on the basis of the velocity of movement of a swipe operation.

The start position of a touch can be predicted by an extrapolation that uses a first and a second detected positions detected as the touch position as illustrated in FIG. 14.

That is, a vector of which the start point is the first detected position detected as the first touch position (the start position of the touch) in a swipe operation and the end point is the second detected position detected as the second touch position can be obtained as the velocity vector of the swipe operation, and a position returned by the velocity vector can be obtained from the first detected position as the predicted position of the start position of the touch.

According to the prediction method by the extrapolation as described above, for example, as illustrated in FIG. 13A, a position that substantially matches the actual start position of the touch, that is, a position inside the swipe area 91R is obtained as the predicted position of the start position of the touch even though the detected position detected as the start position of the touch is dislocated from the actual start position of the touch (a position inside the swipe area 91R) to the left that is the direction of the swipe operation when the user intends to perform the function assigned to the swipe area 91R and starts touching from a position inside the swipe area 91R to perform the swipe operation to the left, even when the position is out of the swipe area 91R.

As a consequence, the function assigned to the swipe area 91R is performed in accordance with the intention of the user in the TV 12.

Meanwhile, when the user, for example, intends to perform the function of moving the cursor assigned to the cursor area 92 and starts touching from a position inside the cursor area 92 close to the swipe area 91R to perform a swipe operation to the left, the predicted position of the start position of the touch is not (rarely) positioned inside the swipe area 91R beyond the actual start position of the touch because the initial speed of the swipe operation for moving the cursor is generally not so fast.

Accordingly, when the user intends to perform the function of moving the cursor assigned to the cursor area 92 and starts touching from a position inside the cursor area 92 close to the swipe area 91R to perform a swipe operation to the left, the function assigned to the swipe area 91R is not performed, and the function of moving the cursor assigned to the cursor area 92 is performed in accordance with the intention of the user.

Here, for example, the start position of a touch above can be predicted only when the position obtainment period is delayed from normal besides being predicted all the time.

In addition, when the start position of a touch is predicted, the swipe area 91 can be changed depending on the predicted position obtained by predicting the start position of the touch as illustrated in FIGS. 7A and 7B.

As described above, predicting the start position of a touch on the basis of the velocity of movement of a swipe operation by an extrapolation or the like illustrated in FIG. 14 can prevent the detected position detected as the start position of the touch from being positioned outside the swipe area 91R and the function assigned to the swipe area 91R from not being performed against the intention of the user due to the fast initial speed of a swipe operation regardless of when, for example, the swipe operation is performed for performing the function assigned to the swipe area 91R from a position inside the swipe area 91R as the start position of the touch.

Discarding a Detected Position Detected during a Predetermined Period from the Start of a Touch

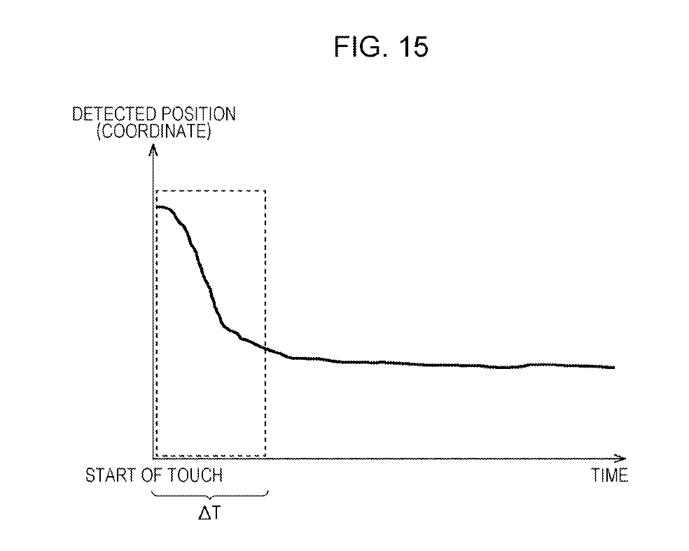

FIG. 15 is a diagram illustrating an example of a temporal change in a detected position that is detected as a touch position.

As illustrated in FIG. 15, the detected position detected as a touch position greatly wobbles immediately after a touch is started in the touch detection area of the touchpad 22 and thereafter is stabilized.

There, the determination unit 82 may discard the detected position detected as the touch position during a predetermined period ΔT from the start of the touch and may not use the detected position in determining an operation of the remote controller 11 or the like.

That is, the determination unit 82 may not use the detected position detected during the predetermined period ΔT from the start of the touch among detected positions detected as the touch positions in determining an operation of the remote controller 11 or the like and may use a detected position detected after the predetermined period ΔT elapses.

As described above, discarding the detected position detected as the touch position during the predetermined period ΔT from the start of the touch can improve operability of the touchpad 22.

That is, the determination unit 82 can be prevented from erroneously determining that the cursor area 92 is touched due to the detected position detected as the touch position wobbling immediately after the start of the touch when the user, for example, intends to touch the swipe area 91R and touches a position inside the swipe area 91R close to the cursor area 92.

In addition, the determination unit 82 can be prevented from erroneously determining that the swipe area 91R is touched due to the detected position detected as the touch position wobbling immediately after the start of the touch when the user, for example, intends to touch the cursor area 92 and touches a position inside the cursor area 92 close to the swipe area 91R.

Furthermore, the determination unit 82 can be prevented from erroneously determining that not a tap but a swipe operation (or a flick operation) is performed due to the detected position detected as the touch position wobbling immediately after the touch when the user, for example, intends to tap and touches the touch detection area of the touchpad 22.

In a push operation on the touchpad 22, the detected position detected as the touch position greatly wobbles and thereafter is stabilized from when the user starts contacting the touchpad 22 (the touch detection area thereof) with the finger until the contact area of the finger of the user on the touchpad 22 becomes sufficiently great to apply a pressure for pushing the touchpad 22.

Discarding the detected position detected as the touch position during the predetermined period ΔT from the start of the touch can prevent the detected position detected as the touch position during the push operation on the touchpad 22 from greatly wobbling, thus being capable of improving the accuracy of the detected position.

Furthermore, discarding the detected position detected as the touch position during the predetermined period ΔT from the start of the touch allows the determination unit 82 to be able to adopt a small value as a threshold for determining a stop (the width of vibration of the detected position that can be regarded as the stop) compared with the case of not discarding the detected position and to be able to determine the stop of the touch position with high accuracy when, for example, determining the stop of the touch position (or movement of the touch position) on the touchpad 22 (the touch detection area thereof).

### Push Determination Area

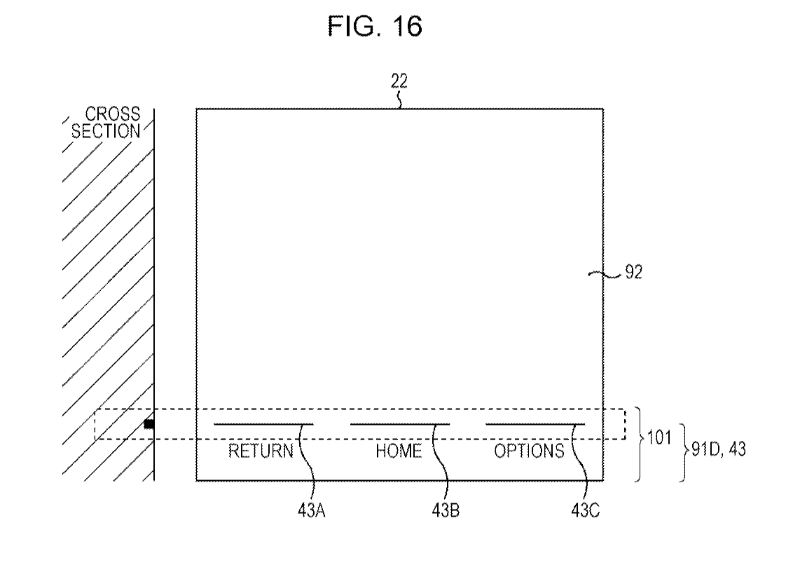

FIG. 16 is a plan view illustrating a schematic configuration example of the touchpad 22 (the touch detection area thereof).

In FIG. 16, the touch detection area of the touchpad 22 is sectioned into two assignment areas of the swipe area 91D and the cursor area 92.

As illustrated in FIG. 5, the swipe area 91D corresponds to the area 43 in FIG. 3.

Three keys 43A, 43B, and 43C are disposed in the horizontal direction in the swipe area 91D that is the area 43 as illustrated in FIG. 3. Furthermore, the names “RETURN”, “HOME”, and “OPTIONS” of the keys 43A to 43C are printed below the keys 43A to 43C.

The keys 43A to 43C are formed as a horizontally linear convex portion on the boundary between the swipe area 91D and the cursor area 92 in the touch detection area of the touchpad 22 and also functions as a unit that allows the user to recognize the boundary between the swipe area 91D and the cursor area 92.

Predetermined functions (processes) are performed when the keys 43A to 43C are pushed as illustrated in FIG. 3.

Regarding the keys 43A to 43C, the determination unit 82, for example, sets a push determination area 101 in the touch detection area of the touchpad 22 for determining that the keys 43A to 43C are touched during a push operation on the touchpad 22. When the touch position (the detected position detected thereas) is positioned inside the push determination area 101 during the push operation on the touchpad 22, the determination unit 82 determines that the keys 43A to 43C are pushed.

As a method for setting the push determination area 101, for example, a first setting method of setting the push determination area 101 to the swipe area 91D where the keys 43A to 43C are disposed is used.

However, the user generally tends to touch the upper side of the convex portion to push the touchpad 22 when pushing the keys 43A to 43C in the case where the keys 43A to 43C are formed as the convex portion.

Accordingly, when the user touches the upper side of the convex portion as the keys 43A to 43C to push the touchpad 22 in the case where the push determination area 101 is set to the swipe area 91D where the keys 43A to 43C are disposed on the boundary thereof, the determination unit 82 determines that the touch position during the push operation is not positioned inside the push determination area 101 for the keys 43A to 43C. As a consequence, the determination unit 82 does not determine that the keys 43A to 43C are pushed.

In the present embodiment, a second setting method of setting the push determination area 101 separately from the swipe area 91D where the keys 43A to 43C are disposed is adopted as the method for setting the push determination area 101.

In FIG. 16, an area extended from the swipe area 91D where the keys 43A to 43C are disposed to the upper side thereof is set to the push determination area 101 considering that the user tends to touch the upper side of the convex portion as the keys 43A to 43C to push the touchpad 22 as described above.

As described above, setting the push determination area 101 as an individual area separately from the swipe area 91D where the keys 43A to 43C are disposed, that is, for example, setting the push determination area 101 to the area extended from the swipe area 91D to the upper side thereof as illustrated in FIG. 16 allows the determination unit 82 to be able to determine that the keys 43A to 43C are pushed and to perform the functions assigned to the keys 43A to 43C in the TV 12 even when the user touches the upper side of the convex portion as the keys 43A to 43C to push the touchpad 22.

Accordingly, missing the push operation on the keys 43A to 43C, that is, not performing the functions assigned to the keys 43A to 43C regardless of when the user pushes (intends to push) the keys 43A to 43C can be suppressed.

### Suppression of Determination of a Touch

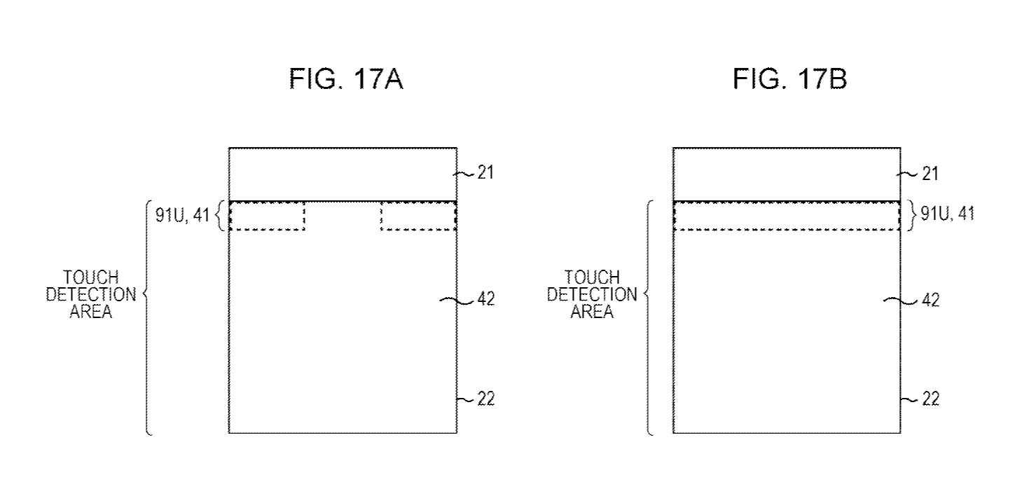

FIGS. 17A and 17B are plan views illustrating a configuration example of a part of the operation panel of the remote controller 11.

The hard key unit 21 is disposed up the touchpad 22 (the touch detection area thereof) in the form of being adjacent to the touchpad 22 as illustrated in FIG. 3.

In FIGS. 17A and 17B, the touch detection area of the touchpad 22 is sectioned into two assignment areas of the swipe area 91U and the cursor area 92.

As illustrated in FIG. 5, the swipe area 91U corresponds to the area 41 in FIG. 3.

The hard key unit 21 is adjacent to the swipe area 91U that is the area 41.

The user may unintentionally touch the swipe area 91U when operating (pushing) the hard key unit 21 since the hard key unit 21 is adjacent to the swipe area 91U that is the area 41 as described above.

In this case, a function assigned to a touch on the swipe area 91U, that is, for example, displaying the menu or the like is unintentionally performed because of the touch on the swipe area 91U in the TV 12.

To prevent the function from being performed against the intention of the user as described above, the determination unit 82, for example, suppresses determining a touch on the swipe area 91U (determining that the swipe area 91U is touched) as a proximity area that is in proximity to the hard key unit 21 in the touch detection area on the basis of, for example, the touch position (the detected position detected thereas) in the touch detection area or the area (contact area) of the touch.

FIG. 17A illustrates a method for suppressing determination of a touch on the swipe area 91U on the basis of the touch position.

The determination unit 82 suppresses determining a touch on the swipe area 91U (does not determine that the swipe area 91U is touched) by regarding the touch as an unintended touch (contact) of the user on the swipe area 91 while the hard key unit 21 is pushed when the touch position is positioned at a part in proximity to the hard key unit 21, that is, for example, the left and right part of the swipe area 91U except the central part as illustrated in FIG. 17A (the part surrounded with a dotted line in FIG. 17A).

Meanwhile, when the touch position is positioned at the central part in the swipe area 91U that is in proximity to the hard key unit 21 in FIG. 17A, the determination unit 82 determines that the swipe area 91U is touched regarding the touch as an intended touch of the user on the swipe area 91U of the touch detection area of the touchpad 22.

FIG. 17B illustrates a method for suppressing determination of a touch on the swipe area 91U on the basis of the area of the touch.

Even when a part in proximity to the hard key unit 21, that is, for example, the swipe area 91U (the part surrounded with a dotted line in FIG. 17B) is touched, the determination unit 82 suppresses determining the touch on the swipe area 91U by regarding the touch as an unintended touch of the user on the swipe area 91U while the hard key unit 21 is pushed in a case where the area of the touch is smaller than or equal to a predetermined constant value.

Meanwhile, when the area of the touch on the swipe area 91U of the touch detection area of the touchpad 22 exceeds the predetermined constant value in FIG. 17B, the determination unit 82 determines that the swipe area 91U is touched regarding the touch as an intended touch of the user on the swipe area 91U of the touch detection area of the touchpad 22.

As described above, suppressing determination of the touch on, for example, the swipe area 91U as the proximity area that is in proximity to the hard key unit 21 in the touch detection area on the basis of the touch position or the area of the touch can prevent the function assigned to the swipe area 91U from being performed when the user unintentionally touches the swipe area 91U while pushing the hard key unit 21 that is adjacent to the swipe area 91U.

Suppressing the determination of the touch above can be performed only when the hard key unit 21 that is adjacent to the touch detection area is operated.

An Embodiment of a Terminal to which the Present Technology is Applied

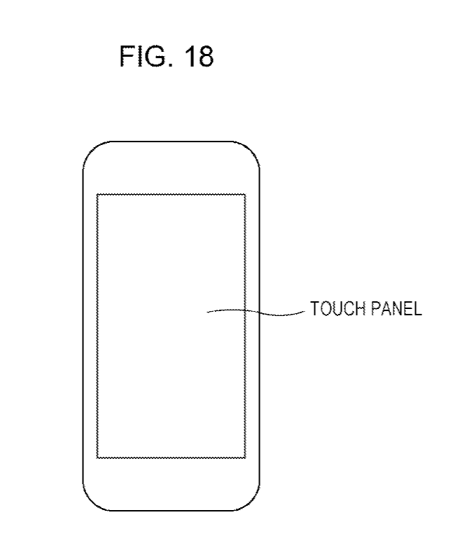

FIG. 18 is a plan view illustrating a configuration example of an embodiment of a terminal to which the present technology is applied.

The terminal in FIG. 18, for example, is a smartphone, a tablet, or the like, and includes a touch panel that both displays an image of an item and the like and detects a touch.

The terminal in FIG. 18 is different from the TV system in FIG. 1. The touch panel both displays an image and detects a touch in the terminal whereas the remote controller 11 including the touchpad 22 detects a touch, and the TV 12 including the display unit 84 displays an image in the TV system.

However, operability of the touch panel of the terminal in FIG. 18 is the same as that of the touchpad 22 and thus, will not be described.

Description of a Computer to which the Present Technology is Applied

The series of processes described above can be performed by hardware or can be performed by software. When the series of processes is performed by software, a program that constitutes the software is installed on a versatile computer or the like.

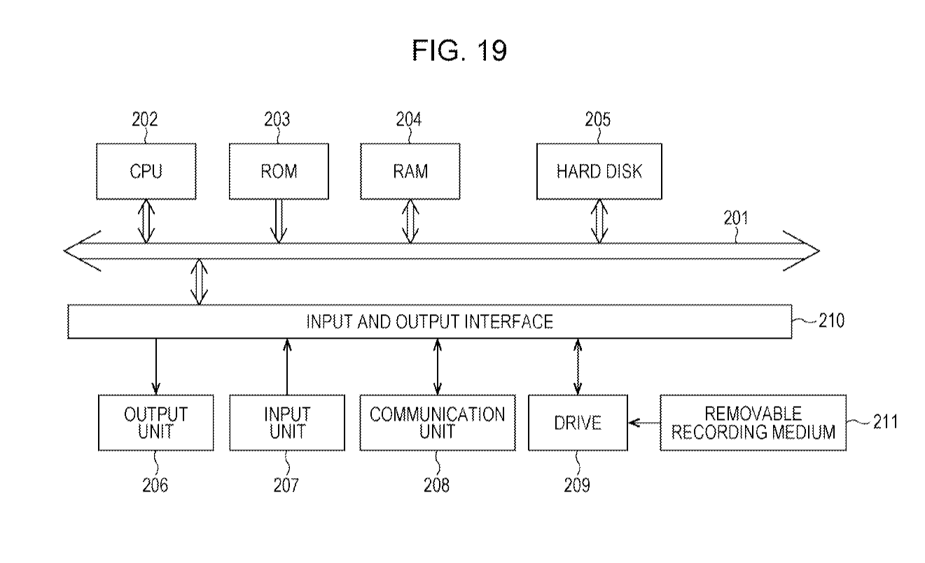

FIG. 19 illustrates a configuration example of an embodiment of a computer on which the program that executes the series of processes described above is installed.

The program can be recorded in advance in a hard disk 205 or a ROM 203 as a recording medium incorporated in the computer.

Alternatively, the program can be stored (recorded) in a removable recording medium 211. The removable recording medium 211 can be provided as so-called package software. As the removable recording medium 211, for example, a flexible disk, a compact disc read-only memory (CD-ROM), a magneto-optical (MO) disk, a digital versatile disc (DVD), a magnetic disk, a semiconductor memory, or the like is used.

Besides being installed on the computer from the removable recording medium 211 as described above, the program can be downloaded on the computer through a communication network or a broadcast network and installed in the incorporated hard disk 205. That is, the program, for example, can be wirelessly transferred to the computer via a satellite for digital satellite broadcasting from a download site or can be transferred to the computer in a wired manner through a network such as a local area network (LAN) and the Internet.

The computer incorporates a central processing unit (CPU) 202. An input and output interface 210 is connected to the CPU 202 via a bus 201.

The CPU 202 executes the program stored in the read-only memory (ROM) 203 according to a command when the user operates an input unit 207 or performs the like to input the command through the input and output interface 210. Alternatively, the CPU 202 executes the program stored in the hard disk 205 after loading the program into a random access memory (RAM) 204.

Consequently, the CPU 202 performs a process according to the flow charts described above or performs a process with the configuration in the block diagram described above. Then, the process result, for example, is output from an output unit 206 through the input and output interface 210, is transmitted from a communication unit 208, or is recorded in the hard disk 205 by the CPU 202.

The input unit 207 is configured of a keyboard, a mouse, a microphone, and the like. The output unit 206 is configured of a liquid crystal display (LCD), a speaker, and the like.

In the present specification, the process performed by the computer according to the program is not necessarily performed in a time-series manner in an order described as the flow charts. That is, the process performed by the computer according to the program includes a process executed individually or in a parallel manner (for example, a parallel process or a process performed by an object).

In addition, the program may be processed by one computer (processor) or may be processed in a distributed manner by multiple computers. Furthermore, the program may be executed after being transferred to a remote computer.

In the present specification, the system means a collection of multiple constituents (devices, modules (components), and the like). It does not matter whether all the constituents are in the same case. Accordingly, multiple devices accommodated in separate cases and connected through a network and one device with multiple modules accommodated in one case are all included in the system.

Embodiments of the present technology are not limited to the embodiment described above. Various modifications may be made without departing from the gist of the present technology.

For example, the present technology can have a configuration of cloud computing in which one function is divided among multiple devices through a network and is jointly processed by the multiple devices.

In addition, besides being executed by one device, each step described in the flow charts above can be divided among multiple devices and executed by the multiple devices.

Furthermore, when multiple processes are included in one step, the multiple processes included in the one step can be divided among multiple devices and executed by the multiple devices besides being executed by one device.

In the present embodiment, a touch sensor such as the touchpad 22 and the touch panel is adopted as a device for detecting a touch. Besides, for example, a device that detects a virtual touch on a touch detection area that is a virtual touch detection area set in free space on the basis of a gesture, a line of sight, a biosignal such as brainwaves and nerves, or the like can be adopted as a device for detecting a touch.

Furthermore, although the present technology is described with the case where the present technology is applied to the TV system in FIG. 1 and the terminal in FIG. 18 in the present embodiment, the present technology can be applied to any touch devices that include a touch sensor such as a touchpad and a touch panel or further to a device or the like that detects a touch on a virtual touch detection area without a touch sensor as described above.

In addition, a part or the entire of functions of the determination unit 82 in the TV 12 can be assigned to the remote controller 11.

Furthermore, the effect described in the present specification is only illustrative and is not limited. Other effects may be achieved.

The present technology can have the following configurations.

1. A control device including an area change unit that changes an assignment area which is a part of a touch detection area where a touch of a user is detected and is an area to which a predetermined function is assigned depending on a start position of a touch of the user or a position obtainment period during which a touch position of the user is obtained.

2. The control device according to 1, in which the area change unit restores the assignment area after being changed after a predetermined period elapses from when the touch of the user is released.

3. The control device according to 2, in which the area change unit enlarges the assignment area when the start position of the touch is positioned inside the assignment area and shrinks the assignment area when the start position of the touch is positioned outside the assignment area.

4. The control device according to 2 or 3, in which the area change unit restores the assignment area after being changed even before the predetermined period elapses when the function assigned to the assignment area is changed.

5. The control device according to any one of 1 to 4, in which the area change unit enlarges the assignment area when the position obtainment period is delayed from normal.

6. The control device according to any one of 1 to 5, in which the start position of the touch is predicted on the basis of a velocity of movement of the touch of the user, and the area change unit changes the assignment area depending on a predicted position that is obtained by predicting the start position of the touch.

7. The control device according to 6, in which the control device predicts the start position of the touch by an extrapolation that uses a first and a second detected positions which is detected as the touch position.

8. The control device according to any one of 1 to 7, in which the control device discards the detected position that is detected during a predetermined period from the start of the touch among detected positions that is detected as the touch position.

9. The control device according to any one of 1 to 8, in which a key that is pushed is arranged in the assignment area, and the control device sets a push determination area in which a touch of the key is determined during a push operation separately from the assignment area.

10. The control device according to any one of 1 to 9, in which a hard key is arranged being adjacent to the touch detection area, and the control device suppresses detecting the touch on a proximity area that is in proximity to the hard key in the touch detection area.

11. The control device according to 10, in which the control device suppresses detecting the touch on the proximity area depending on an area of the touch on the proximity area.

12. The control device according to any one of 1 to 11, in which the assignment area is in a vicinity of a boundary of the touch detection area, and the predetermined function that is performed with an inward swipe operation from the boundary side of the touch detection area as a trigger is assigned to the assignment area.

13. A control method including changing an assignment area that is a part of a touch detection area where a touch of a user is detected and is an area to which a predetermined function is assigned depending on a start position of a touch of the user or a position obtainment period during which a touch position of the user is obtained.

14. A program that causes a computer to function as an area change unit that changes an assignment area which is a part of a touch detection area where a touch of a user is detected and is an area to which a predetermined function is assigned depending on a start position of a touch of the user or a position obtainment period during which a touch position of the user is obtained.

It should be understood by those skilled in the art that various modifications, combinations, sub-combinations and alterations may occur depending on design requirements and other factors insofar as they are within the scope of the appended claims or the equivalents thereof.

What is claimed is:

1. A control device comprising:
an area change unit that changes an assignment area which is a part of a touch detection area where a touch of a user is detected and is an area to which a predetermined function is assigned depending on a start position of a touch of the user or a position obtainment period during which a touch position of the user is obtained.

2. The control device according to claim 1,
wherein the area change unit restores the assignment area after being changed after a predetermined period elapses from when the touch of the user is released.

3. The control device according to claim 2,
wherein the area change unit enlarges the assignment area when the start position of the touch is positioned inside the assignment area and shrinks the assignment area when the start position of the touch is positioned outside the assignment area.

4. The control device according to claim 3,
wherein the area change unit restores the assignment area after being changed even before the predetermined period elapses when the function assigned to the assignment area is changed.

5. The control device according to claim 1,
wherein the area change unit enlarges the assignment area when the position obtainment period is delayed from normal.

6. The control device according to claim 3,
wherein the start position of the touch is predicted on the basis of a velocity of movement of the touch of the user, and
the area change unit changes the assignment area depending on a predicted position that is obtained by predicting the start position of the touch.

7. The control device according to claim 6,
wherein the control device predicts the start position of the touch by an extrapolation that uses a first and a second detected positions which is detected as the touch position.

8. The control device according to claim 3,
wherein the control device discards the detected position that is detected during a predetermined period from the start of the touch among detected positions that is detected as the touch position.

9. The control device according to claim 3,
wherein a key that is pushed is arranged in the assignment area, and
the control device sets a push determination area in which a touch of the key is determined during a push operation separately from the assignment area.

10. The control device according to claim 3,
wherein a hard key is arranged being adjacent to the touch detection area, and
the control device suppresses detecting the touch on a proximity area that is in proximity to the hard key in the touch detection area.

11. The control device according to claim 10,
wherein the control device suppresses detecting the touch on the proximity area depending on an area of the touch on the proximity area.

12. The control device according to claim 3,
wherein the assignment area is in a vicinity of a boundary of the touch detection area, and
the predetermined function that is performed with an inward swipe operation from the boundary side of the touch detection area as a trigger is assigned to the assignment area.

13. A control method comprising:
changing an assignment area that is a part of a touch detection area where a touch of a user is detected and is an area to which a predetermined function is assigned depending on a start position of a touch of the user or a position obtainment period during which a touch position of the user is obtained.

14. A program that causes a computer to function as:
an area change unit that changes an assignment area which is a part of a touch detection area where a touch of a user is detected and is an area to which a predetermined function is assigned depending on a start position of a touch of the user or a position obtainment period during which a touch position of the user is obtained.
